(19) United States
(12) Patent Application Publication
(10) Pub. No.: US 2005/0180543 A1
(43) Pub. Date: Aug. 18, 2005

(54) Aerosol particle classification apparatus

(76) Inventors: Kikuo Okuyama, Higashihiroshima City (JP); Manabu Shimada, Higashihiroshima City (JP); Mansoo Choi, Seoul (KR); Bangwoo Han, Jeonju City (KR)

Correspondence Address: SMITH PATENT OFFICE, 1901 PENNSYLVANIA AVENUE N W, SUITE 200, WASHINGTON, DC, 20006, US

(21) Appl. No.: 10/928,320

(22) Filed: Aug. 30, 2004

(30) Foreign Application Priority Data
Feb. 18, 2004 (JP) 2004-041691

(51) Int. Cl. G21K 5/08; G01N 15/00

(52) U.S. Cl. 378/66

(57) ABSTRACT

Distributed non-charged particles having a desired particle diameter are introduced into a chamber. A photoionizer in which a soft X-ray power is adjustable is attached to the chamber, to charge the particles within the chamber. The power level of the soft X-ray is adjusted by a controller so as to produce singly charged particles. The charged particles are then introduced into a differential mobility analyzer for classification, thus producing monodisperse standard particles having particle diameter of 0.1 to 1.0 μm.

### BACKGROUND OF THE INVENTION

1. Field of the Invention

The present invention relates to an aerosol particle classification apparatus for generating singly charged, monodisperse standard particles.

2. Discussion of the Related Art

The generation of monodisperse singly charged particles, in which a single electron is charged, having a predetermined particle diameter is essential in the study of aerosol particles. Such generation of monodisperse singly charged particles is also essential in the configuration of the aerosol particle measuring apparatuses such as impactors, cyclones, and filters. An example of a conventional method of generating monodisperse aerosol particles includes a method of classifying polydisperse particles to particles of equi-mobility using a differential mobility analyzer (DMA). The DMA functions well when aerosol particles smaller than about 0.1 μm are involved. However, since the DMA classifies fine charged particles charged on the basis of electrical mobility defined by the diameter and the charge, when the diameter increases, the multiply charged particles with larger diameter and singly charged particles with small diameter are classified in the DMA with equal electrical mobility. As the diameter increases, the fraction of the multiply charged particles increases, amounting to a ratio not negligible in classifying only the monodisperse particles.

Aerosol particles in the 0.1 to 1.0-μm-diameter range are used in the study of aerosol particles such as in the study relating to cloud nucleation and gas-aerosol reactions. Thus, it is very important to generate monodisperse particles within such diameter range using the DMA. In a prior art, Gupta, A., and McMurry, P. H. (1989), A Device Generation Singly Charged Particles in the 0.1-1.0 μm Diameter Range. Aerosol Sci. Technol. 10:451-462, a low-activity radioactive (0.09 μCi:⁶³Ni) charger is used as an ionization source to reduce the generation of multiply charged particles under conditions of low ion concentration. This reference proposes an apparatus for generating monodisperse, singly charged particles by controlling an extracting position using a charger including a chamber uniformly applied with plating.

In this conventional technique, the charging time and the aerosol flow rate must be controlled each time when the size of particles is changed. The charging time depends on the pattern of aerosol flow in the charger as well as on the aerosol flow rate and is, hence, difficult to estimate. Therefore, this technique has a disadvantage that it is difficult to control the aerosol flow rate and the extracting position to obtain particles of an adequate monodispersity in the overall particle size range of 0.1 to 1.0 μm.

On the contrary, if the ion concentration of the charged particle could be controlled, the particle charging state can be easily regulated so as to be largely singly charged in a variety of aerosol conditions without the need to change the aerosol flow rate even if the particle diameter or the concentration of the introduced aerosol particle is changed.

### SUMMARY OF THE INVENTION

The present invention is made in view of the above disadvantages, and it is an object of the invention to provide a monodisperse aerosol particle classification apparatus for obtaining singly charged particles without changing the flow rate or the extracting position.

The monodisperse aerosol particle classification apparatus according to the present invention comprises a chamber, an introducing unit, an X-ray source, a exhausting unit, and a differential mobility analyzer. The introducing unit flows gas containing aerosol particles serving as an object to be processed, into the chamber. The X-ray source is arranged so as to face the chamber. The power level of the X-ray source for emitting the X-ray having the usable wavelength in the range of 0.13 to 2 nm is adjustable. The exhausting unit is connected to the chamber and exhausts the aerosol particles charged by the X-ray from the chamber. The differential mobility analyzer is connected to the exhausting unit, classifies the charged particles passed through the exhausting unit by the electrical mobility thereof, and separates the particles having predetermined electrical mobility.

According to the present invention with the above characteristics, monodisperse, singly charged aerosol particles, especially, aerosol particles with reduced multiply charged particle concentration can be classified by the classification in the differential mobility analyzer by adjusting the power level of the X-ray source.

### BRIEF DESCRIPTION OF THE DRAWINGS

FIG. 1A is a schematic diagram showing an entire configuration of a monodisperse aerosol particle classification apparatus according to a preferred embodiment of the present invention, and FIG. 1B is a schematic diagram showing a configuration of a differential mobility analyzer;

FIG. 2 is a graph showing a ratio of singly charged particle concentration and doubly charged particle concentration to all particle concentration as a function of particle diameter, with the change of the power level of photoionizer according to basic equations of the present invention;

FIG. 3 is a graph showing a ratio of singly charged particle concentration and doubly charged particle concentration to all particle concentration as a function of particle diameter, with the change of particle concentration according to the basic equations of the present invention;

FIG. 4 is a graph showing a ratio of singly charged particle concentration and doubly charged particle concentration to all particle concentration as a function of particle diameter, with the change of charging time according to the basic equations of the present invention;

FIG. 5 is a graph showing a relationship between applied voltage in a chamber and ion current when the power of the photoionizer is changed;

FIG. 6 is a table showing the relationship of X-ray power, saturated current and ion concentration;

FIGS. 7A and 7B are graphs showing relative particle concentration with regard to electrical mobility; and

FIG. 8A is a graph showing concentration ratio of singly charged particles and doubly charged particles when the power of photoionizer for generating X-ray is changed, and FIG. 8B is a graph showing concentration ratio of singly charged particle and all particle concentration when the power of photoionizer for generating X-ray is changed.

### DESCRIPTION OF THE PREFERRED EMBODIMENT

The present invention utilizes a soft X-ray photoionizer, in which the X-ray power is adjustable, in place of the low-activity radioactive charger to generate singly charged, monodisperse aerosol particles.

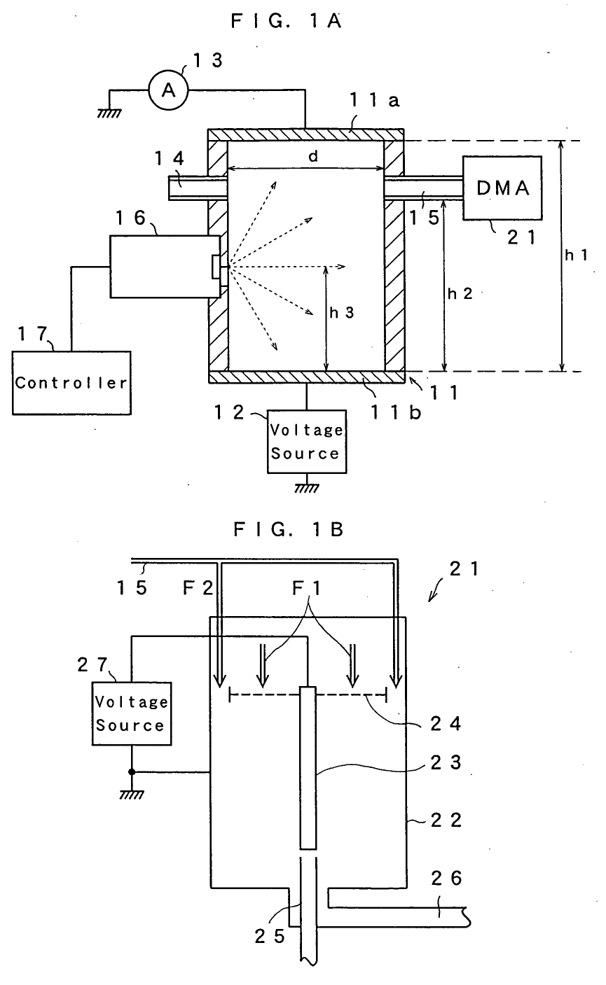

As shown in FIGS. 1A and 1B, a classification apparatus with a soft X-ray charger will now be described. FIG. 1A is a schematic diagram showing the entire configuration of the monodisperse aerosol particle classification apparatus according to a preferred embodiment of the present invention. In the figure, a chamber 11 includes side walls made of cylindrical PFE (polytetrafluoroethlyene), and stainless electrodes 11a and 11b are arranged on the upper and lower parts, thus forming a container. A direct current voltage source 12 is connected to the lower electrode 11b, and the upper electrode 11a is grounded via an ammeter 13. An inlet duct 14 for introducing non-charged aerosol particles functioning as an introducing unit and an outlet duct 15 functioning as an exhausting unit are arranged on the left and right side walls of the chamber 11, respectively. An inner diameter d of the chamber 11 is for example, 60 mmφ, an internal height h1 is 90 mm, and a position h2 where the inlet duct 14 and the outlet duct 15 are attached is the position 70 mm above the bottom surface. As shown in the figure, a photoionizer 16 is arranged at a position h3 45 mm above the bottom surface. The photoionizer 16 is a charger for producing a soft X-ray having a wavelength of, for example, 0.13 nm to 2 nm, preferably 0.2 nm to 2 nm, and a controller 17 is connected thereto to set the current value as well as the voltage for regulating the power of the photoionizer 16. The controller 17 may select a value equal to or less than 200.0 μA as the current value and a value equal to or less than 10.0 KV as the voltage value. Maximum power is obtained with 200.0 μA and 10.0 KV.

A differential mobility analyzer (DMA) 21 functioning as a classification apparatus for classifying the charged particles is connected to the outlet duct 15 of the chamber. The DMA 21 is configured in such a manner that voltage is applied to the cylindrical electrodes of the side walls and the center to classify the charged polydisperse aerosol particles introduced from the side wall on the basis of the electrical mobility, thus classifies only the particles having predetermined electrical mobility. FIG. 1B is a schematic diagram showing the configuration of the DMA 21. As shown in the figure, a cylindrical central electrode 23 is arranged coaxial with the central portion of a cylinder 22, and a mesh 24 with a slightly smaller diameter than the cylinder 22 is arranged coaxially with the central electrode 23. Clean air F1 flows through the mesh 24. The aerosol particles F2 from the above-mentioned outlet duct 15 flows into the peripheral portion of the cylinder 22. An outlet duct 25 is arranged at the lower end of the central electrode 23 with a gap in between, with an opening of the outlet duct 25 so as to face the lower surface of the central electrode 23. A second outlet duct 26 for exteriorly exhausting the aerosol particles not drawn by the outlet duct 25 is arranged at a portion below the cylinder 22. A direct current voltage source 27 is arranged for applying voltage to the side face of the cylinder 22 and the central electrode 23.

Voltage is applied between the cylinder 22 and the central electrode 23, and the aerosol is introduced to the DMA 21, as shown in the figure. This allows the aerosol particles from the outlet duct 15 supplied to the outer periphery portion to approach the central electrode due to an electric field, and only the particles having predetermined electrical mobility are drawn by the outlet duct 25 from the gap. Thus only the particles having predetermined electrical mobility are obtained. The electrical mobility is determined by the ratio of the charge and the particle diameter of the relevant particle. Therefore, if the introduced fine-particles are singly charged particles, only the particles having substantially the same diameter can be extracted by classification.

The previous studies showed that the charging of the aerosol particle using a soft X-ray charger could be well evaluated by the diffusion bipolar/unipolar charging theory. The basic equations of the bipolar diffusion charging can be expressed as follows:

$$\begin{matrix}\frac{ⅆ {n}_{ion}^{+}}{ⅆ t} = - α {n}_{ion}^{+} {n}_{ion}^{-} - {\sum }_{p = - ∞}^{+ ∞} {β}_{p}^{+} {n}_{p} {n}_{ion}^{+} + S & ( 1 ) \\ \frac{ⅆ {n}_{ion}^{-}}{ⅆ t} = - α {n}_{ion}^{+} {n}_{ion}^{-} - {\sum }_{p = - ∞}^{+ ∞} {β}_{p}^{-} {n}_{p} {n}_{ion}^{-} + S & ( 2 ) \\ \frac{ⅆ {n}_{p}}{ⅆ t} = {β}_{p + 1}^{-} {n}_{p + 1} {n}_{ion}^{-} - {β}_{p}^{-} {n}_{p} {n}_{ion}^{-} + {β}_{p - 1}^{+} {n}_{p - 1} {n}_{ion}^{+} - {β}_{p}^{+} {n}_{p} {n}_{ion}^{+} & ( 3 )\end{matrix}$$

where
nᵢₒₙ⁺ is the concentration of positive ions (ions/m³),
nᵢₒₙ⁻ is the concentration of negative ions (ions/m³),
nₚ is the concentration of p-charged particles (particles/m³),
nₚ₊₁ is the concentration of (p+1) charged particles (particles/m³),
nₚ₋₁ is the concentration of (p−1) charged particles (particles/m³),
βₚ⁺ is the combination coefficient of a p-charged particle with a positive ion,
βₚ⁻ is the combination coefficient of a p-charged particle with a negative ion,
βₚ₊₁⁻ is the combination coefficient of a (p+1) charged particle with a negative ion,
βₚ₋₁⁺ is the combination coefficient of a (p−1) charged particle with a positive ion,
α is a recombination constant (1.6×10⁻¹² (m³/S)), and
S is the production rate of bipolar ions.

Equation (1) represents changes in the concentration of positive ions with time and Equation (2) represents changes in the concentration of negative ions with time. In these equations, the first, second, and third terms on the right-hand side indicate the loss rate due to the recombination of bipolar ions, the loss rate due to collision with particles, and the production rate by the soft X-ray photoionizer, respectively. Equation (3) represents changes in concentrations of p-charged particles with time. Each term on the right-hand side of the equation expresses the gain or loss rate of p-charged particles due to collisions with ions. In the calculation, 130 and 100 amu (amu: atomic mass unit) are used for mass of positive and negative ions. 1.1×10⁻⁴ and 1.3×10⁻⁴ m²/(V·s) are used for electrical mobility of positive and negative ions, respectively.

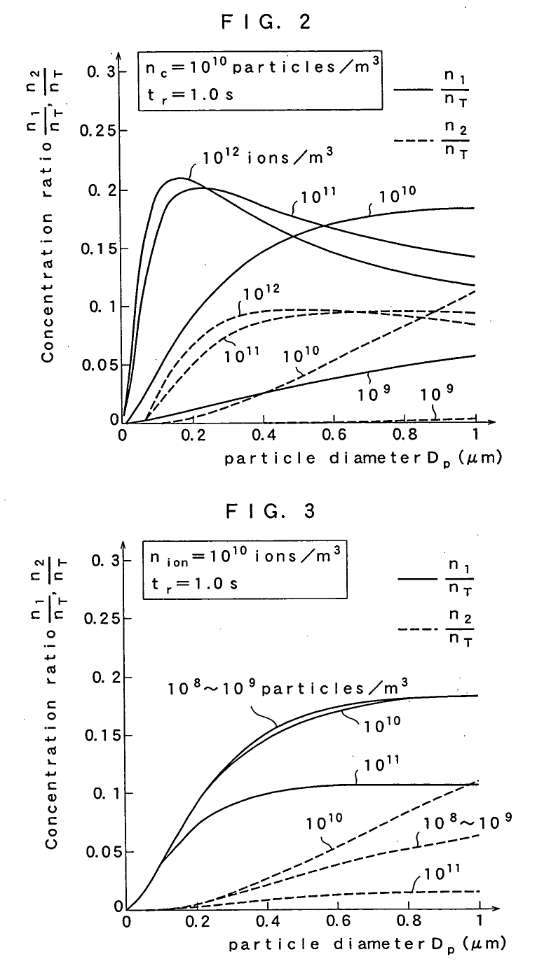

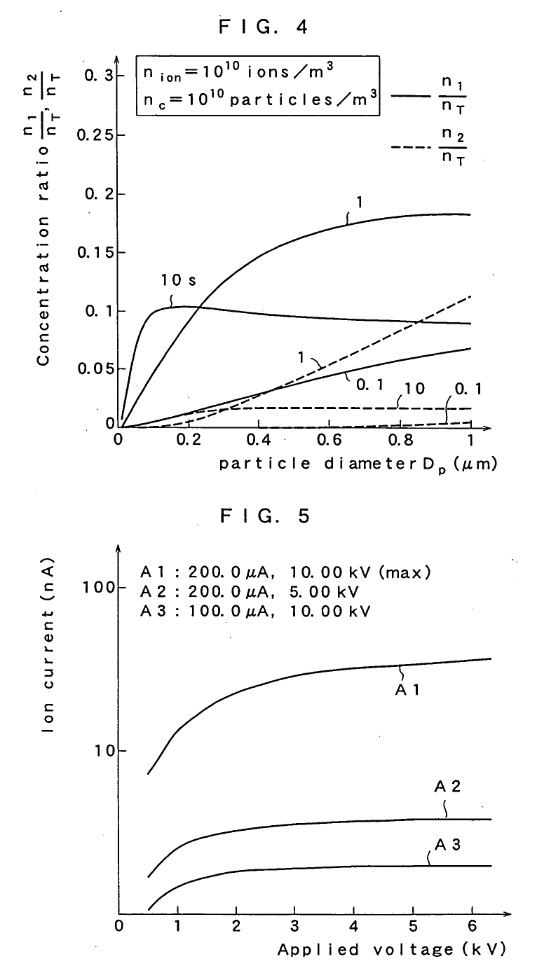

Calculation results of n₁/n_{T} and n₂/n_{T} of when the concentration of all particles n_{c}, ion concentration nᵢₒₙ, and the charging time tᵣ are changed based on the above equations are shown in FIGS. 2 to 4, where n₁ is a singly charged particle concentration to a certain particle diameter Dₚ, n₂ is a doubly charged particle concentration to the particle diameter Dₚ, and n_{T} is a concentration of all particles to the particle diameter Dₚ. FIG. 2 is a graph showing the concentration ratio of singly charged particles and doubly charged particles to all particle concentrations n_{T} as a function of the particle diameter Dₚ (μm) when the power level of the soft X-ray photoionizer is changed between 10¹² ions/m³ and 10⁹ ions/m³ when shown with ion concentration nᵢₒₙ, where the concentration n_{c} of all particles introduced into the chamber is set to 10¹⁰ particles/m³, and the charging time tᵣ is fixed to 1.0 second. FIG. 3 is a graph showing the concentration ratio n₁/n_{T} and n₂/n_{T} as a function of the particle diameter Dₚ (μm) when the concentration n_{c} of all particles introduced into the chamber is changed between 10⁸ and 10¹¹ particles/m³, where the power level of the soft X-ray photoionizer represented by ion concentration is 10¹⁰ ions/m³ and the charging time tᵣ is fixed to 1.0 second. FIG. 4 is a graph showing the concentration ratio as a function of the particle diameter Dₚ (μm) when the charging time tr is changed between 0.1 and 10 seconds, where the power level of the soft X-ray photoionizer represented by ion concentration is 10¹⁰ ions/m³ and the particle concentration n_{c} supplied to the chamber is fixed to 10¹⁰ particles/m³. The concentration of positive ions is assumed to be the same as that of negative ions. Most of the charged particle appears to be singly charged at ion concentration not higher than the particle concentration and at a relatively short charging time. Therefore, as the ion concentration or the charging time is decreased, particles with better monodispersity will be obtained. However, if the ion concentration is too low or if the charging time is too short, the concentration of singly charged particles n₁ also decreases. Therefore, the fraction (n₂/n₁) of two charged particles is targeted to be equal to or less than 5% (σg is about 1.12) in overall diameter range in order to obtain a suitable concentration of n₁. By adjusting the ion generation number using the soft X-ray charger, the generation of monodisperse particles within the particle diameter range of 0.1 to 1.0 μm is readily achieved.

Using the apparatus, the inlet duct 14 and the outlet duct 15 of the chamber 11 are closed and voltage is applied between the upper electrode 11a and the lower electrode 11b of the charger. The ion current generated within the chamber 11 by the electric field is measured by the ammeter 13. The number concentration of bipolar ions nᵢₒₙ is derived from the following equation (4):
nᵢₒₙ=\sqrt{I₀/(αeV)} (4)
where
I₀ is the saturation current in the charger,
e is an elementary electrical charge (=1.6021×10⁻¹⁹ C), and
V is the volume of the charger (=1.64×10⁻⁴ m²).

FIG. 5 is a graph showing the change in ion current as a function of the applied voltage. Curve A1 shows the ion current as a function of the applied voltage when the photoionizer 16 has the maximum power, or is operated at the current value of 200.0 μA and applied voltage of 10.00 kV; curve A2 shows the ion current when the current is 200.0 μA and the applied voltage is 5.00 kV; and curve A3 shows the ion current when the current is 100.0 μA and the applied voltage is 10.00 kV.

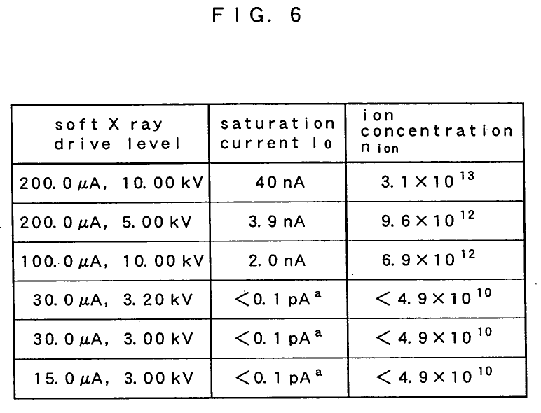

As shown in FIG. 5, when the saturation current Iₒ is obtained for each case, the concentration of bipolar ion can be derived. FIG. 6 shows the bipolar ion number concentration nᵢₒₙ predicted from equation (4). The current 0.1 pA when the driving level of soft X-ray is less than 100.0 μA, and 10.0 kV is the maximum noise current, where “a” indicates that the saturation becomes below such value. That is, “a” is the measuring limit of the saturation current Iₒ; thus, an accurate ion concentration can not be measured, but it is assumed that the ion concentration is changed in response to the current value and the voltage value. Therefore, the power of the soft X-ray may be changed by changing the driving level of the photoionizer 16 so that the ion number concentration of the charger can be adjusted to the desired value readily.

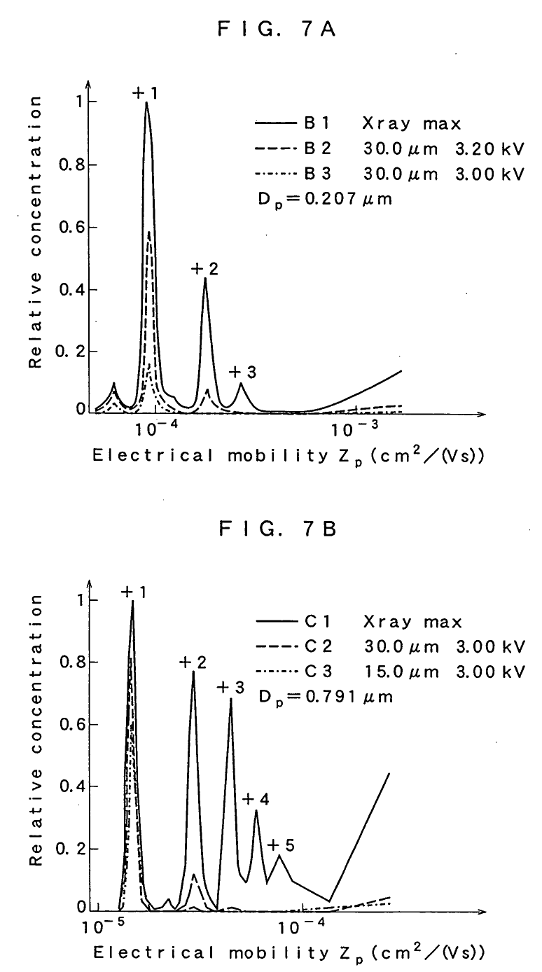

FIGS. 7A and 7B show the charging state of particles where the power level of the soft X-ray photoionizer is changed for the 0.207 μm and 0.791 μm PSL particles, respectively. FIG. 7A shows the relative concentration when the singly charging particle concentration number of the charging particle is 1, with the power of the photoionizer being the maximum value. At the maximum power level of the photoionizer, the relative particle concentration with doubly charged particles is about 0.45, and triply charged particle is about 0.1, as shown with the curve B1. When the power level of the soft X-ray photoionizer charger is lowered to for example, current value of 30.0 μA and voltage value of 3.20 kV, the ratio of the particle concentrations of the singly charged particle and multiply charged particle becomes small, thus only the nearly singly charged particles can be obtained as shown with curve B2. Further, when the current value is lowered to 30.0 μA and the voltage value is lowered to 3.0 kV in the soft X-ray photoionizer charger, only the singly charged particles are obtained, as shown with curve B3. In FIG. 7B, curves C1 to C3 show similar tendency as mentioned above with curves B1 to B3 but with a different particle diameter. Thus, when the soft X-ray power decreases, the fraction of the multiply charged particle rapidly decreases and almost singly charged particles are obtained under the suitable power condition.

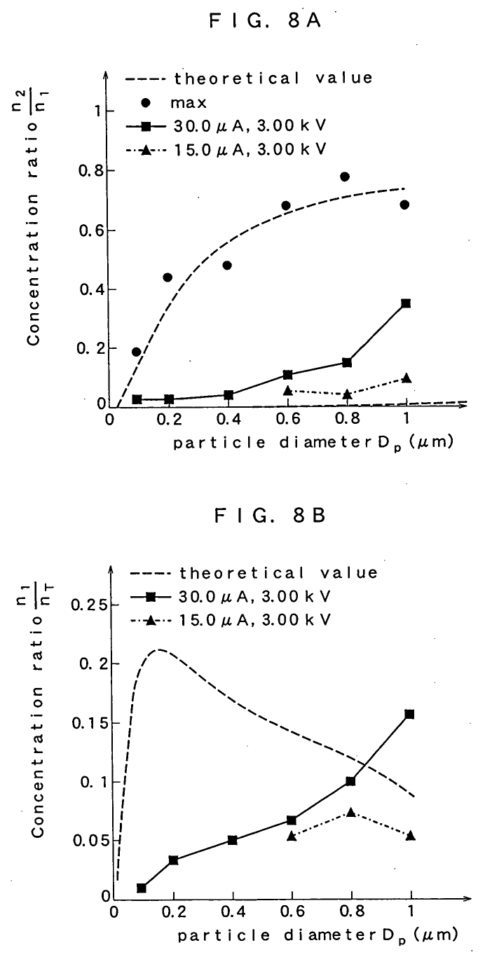

FIG. 8A is a graph showing the ratio n₂/n₁ of the doubly charged particle concentration and the singly charged particle concentration as a function of the particle diameter when the PSL particle is used, and FIG. 8B is a graph showing the ratio of singly charged particle concentration (n₁) and all particle concentration (n_{T}) as a function of the particle diameter. The broken line shows the theoretical value calculated using Equations (1) to (3) for the bipolar equilibrium charging state. When the soft X-ray power is at the maximum value, the soft X-ray brings the aerosol particles into a steady-state charge distribution. The fraction of the doubly charged particles increases with increasing particle size, irrespective of the ion concentration, as shown in FIG. 8A. At an X-ray power of 30.0 μA, 3.0 kV, singly charged particles are easily obtained in the particle diameter range of not more than 0.5 μm. More specifically, in the particle diameter range of 0.1 to 0.2 μm, the fraction of the doubly charged particles to the singly charged particles can be made extremely small to 1 to 2%, and high-monodispersity particles can be obtained. In this case, however, the fraction n₁/n_{T} of the singly charged particles itself is low such as 2 to 3%, as shown in FIG. 8B. If the X-ray power is slightly increased to, for example, 45 μA, 3.0 kV, singly charged particles with a higher concentration can be obtained while the fraction of doubly charged particles is preserved at 5%.

Thus, for the case of larger particles, much lower ion concentration condition is needed to remove the doubly charged particles. As shown in FIG. 7A, with, for example, particles of 0.603 μm and particles of 0.791 μm, low ion concentration of 15 μA, 3.0 kV is necessary to have the n₂/n₁ at about 5%. Even in that case, a non-negligible amount of doubly charged fraction survived for the case of the 1.008 μm particle. Therefore, in this preferred embodiment, monodisperse particles are generated for particles in the range of 0.1 to 1.0 μm by lowering the soft X-ray power level.

In the preferred embodiment, the power of the photoionizer is changed so that the ratio of the doubly charged particles and the singly charged particles is equal to or less than 5%, but the ratio is not limited thereto. To further reduce the ratio of the doubly charged particles, it is necessary to lower the power of the photoionizer. Further, in case a higher ratio of doubly charged particle is acceptable, the power of the photoionizer is made larger, thus increasing the particles to be produced.

The present invention allows generation of monodisperse standard particle in the particle diameter range of 0.1 to 1.0 μm. Therefore, the present invention is applicable to studies of aerosol particles, including the study relating to cloud nucleation and gas-aerosol reactions, as well as to other applications using this classification apparatus.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

The text of Japanese priority application no. 2004-041691 filed on Feb. 18, 2004 is hereby incorporated by reference.

1. An aerosol particle classification apparatus comprising:
a chamber;
an introducing unit which flows gas containing aerosol particle or an object to be processed into said chamber;
an X-ray source which is arranged so as to face said chamber and has an adjustable power level for emitting X-ray of usable wavelength within a range of 0.13 to 2 nm;
a exhausting unit which is coupled to said chamber and exhausts the aerosol particle charged by the X-ray source from said chamber; and
a differential mobility analyzer which is coupled to said exhausting unit, classifies the charged particle passed through said exhausting unit by electrical mobility, and separates the particles of predetermined electrical mobility.

2. An aerosol particle classification apparatus according to claim 1, wherein
said X-ray source includes:
a soft X-ray photoionizer which generates soft X-ray; and
a controller which sets current value and voltage value of driving level of said soft X-ray photoionizer.

3. An aerosol particle classification apparatus according to claim 1, wherein
said X-ray source controls the power level thereof so that a ratio (n₂/n₁) of singly charged particle concentration (n₁) and doubly charged particle concentration (n₂) is at most 5% within said chamber.

4. An aerosol particle classification apparatus according to claim 2, wherein
said X-ray source controls the power level thereof so that a ratio (n₂/n₁) of singly charged particle concentration (n₁) and doubly charged particle concentration (n₂) is at most 5% within said chamber.

5. An aerosol particle classification apparatus according to claim 1, wherein
said X-ray source emits X-ray having usable wavelength within a range of 0.2 to 2 nm.

6. An aerosol particle classification apparatus according to claim 1, wherein
said differential mobility analyzer includes:
a cylinder;
a column-shaped central electrode which is arranged at the center of said cylinder;
a voltage source which applies voltage between said cylinder and said central electrode; and
an outlet duct which is arranged along a central axis of said cylinder with a gap between said central electrode and exhausts classified particles.
